(19) United States
(12) Patent Application Publication
(10) Pub. No.: US 2008/0081754 A1
(43) Pub. Date: Apr. 3, 2008

(54) Container forming machines and methods

(75) Inventors: William Plemons, Squaw Valley, CA (US); Keith Keoppel, Fresno, CA (US)

Correspondence Address: MARK D MILLER;KIMBLE, MACMICHAEL & UPTON, 5260 NORTH PALM AVENUE, SUITE 221, FRESNO, CA, 93704, US

(73) Assignee: W.E. Plemons Machinery Services, Inc.

(21) Appl. No.: 11/903,440

(22) Filed: Sep. 20, 2007

Related U.S. Application Data
(60) Provisional application No. 60/848,065, filed on Sep. 29, 2006.

(51) Int. Cl. B31B 1/00; B31B 1/92; B31B 15/00

(52) U.S. Cl. 493/84; 493/120; 493/89

(57) ABSTRACT

The present invention provides machines, methods and apparatus for forming containers including Bliss style containers of a type in which one or more V-shaped support pillars are formed on one or both of the sidewalls of the container being formed. The machines, methods and apparatus of the present invention form support pillars on the sidewalls of containers using a novel arrangement of one or more unique discs, guides, rollers and grippers.

This application claims the benefit of U.S. Provisional Application No. 60/848,065, filed on Sep. 29, 2006, which is incorporated herein by this reference.

### BACKGROUND OF THE INVENTION

1. Field of the Invention

The present invention relates to methods, machines and apparatus for forming containers with reinforced support pillars in their sidewalls, and more particularly, for forming containers commonly referred to in the packaging industry as “Bliss” boxes, including without limitation those of the type disclosed in U.S. Patent Application Publication No. 2003/0168502 A1 dated Sep. 11, 2003, which publication is incorporated herein by this reference.

2. Description of the Prior Art

The packaging industry has developed numerous paperboard containers over the years to accommodate different products. One such container is commonly known in the industry as a “Bliss-style” container or “Bliss” box. A Bliss box generally comprises three separate panels of material formed into a single container with reinforced sidewalls. The central (base) panel is a multi-sectional rectangular shape, which is folded along various score lines to form a U-shaped structure that defines the bottom, and front and rear ends, of the container. Two separate side panels are attached to the open opposite sides of the structure to form the side walls of the container. The top portion of the container may be formed from the end portions of the central panel, or from a separate fourth panel.

A traditional assembly apparatus for a Bliss box generally comprises: a horizontal track having opposite starting and ending positions; a mandrel movably mounted along said track; a forming frame near one end of the track that receives the mandrel; a pair of hoppers located along the sides of the track, which hold the side panels; and a third hopper located above the track, which hold the central or base panels.

To form a traditional Bliss box, the mandrel begins at a starting or retracted position of the track, and moves toward a forming frame located at the opposite end. As the mandrel progresses along the track, it receives the side panels from the side hoppers. A central panel is deposited between the mandrel and forming frame. As the mandrel extends along the track, it contacts the central panel and pushes it into the forming frame. This causes the central panel to be bent into a U-shaped structure that will eventually be the bottom, and front and rear ends, of the container being formed. The side panels are brought into contact with the central panel during this process. Adhesive is sprayed onto appropriate mating surfaces of the central and side panels while or before they are picked up by the mandrel, to affix the panels together once they are pressed against each other. When the mandrel is fully extended, there is usually a brief delay to allow the adhesive to dry. The completed container is then typically ejected from the forming frame, and the mandrel retracts to its starting position to receive another set of panels to form into another container.

It is important that the paperboard containers suitably protect their contents during the production, distribution and sales processes. However, the structural integrity of the containers may be adversely affected by numerous factors, such as the weight of the container contents, the stacking of containers on top of one another, and the storage of the containers in refrigerated or moist environments. It is a common problem that the central sections of larger Bliss boxes tend to lose strength when loaded with products and placed in tall stacks.

Various features have been invented to address these problems, such as the use of reinforced generally V-shaped support pillars and extended braces in the side panels. (See, e.g., U.S. Patent Application Publication No. 2003/0168502.) One of the Bliss container embodiments of the '502 publication includes a base having a pair of opposed endwalls separated from the base by crease lines, and a pair of attachable sidewalls, each sidewall including at least one reinforcing pillar to form a pair of opposed reinforcing pillars (”the '502 box”). While the '502 publication describes examples of Bliss containers themselves, it does not disclose any machines, methods or apparatus for creating, erecting or forming them; and the traditional machines described above are incapable of forming the V-shaped support pillars of the '502 box.

It is therefore desirable to provide an apparatus and method for assembling a Bliss box having the various features described above, and in the '502 publication. It is further desirable that such a process be entirely automated to maximize the number of boxes assembled. Finally, it is desirable that such a process minimize the number of errors incurred in assembling the boxes, including, but not limited to, those errors caused by misaligned or dislodged boxes.

### SUMMARY OF THE INVENTION

The present invention provides machines, methods and apparatus for forming Bliss containers with various reinforcing features, including, but not limited to, those features disclosed in the '502 publication. In embodiments of the present invention, one or both of the sidewalls (end panels) of the container to be formed are pre-scored for forming one or more support pillars, and a unique set of guides, rollers and mandrel grippers are utilized to form and set the support pillar(s) in the sidewall(s) as each container is formed.

Most embodiments of the machine include a generally horizontal track having opposite ends denoting starting and ending locations (retracted and extended positions for the mandrel); a mandrel movably mounted on the track, the mandrel having one or more grippers, indentations and/or protrusions on its sides; a forming frame near the ending location of the track having an interior passage which receives the mandrel; an overhead hopper located above the track, for holding central panels and delivering them one by one as containers are formed; a pair of hoppers located on opposite sides of the track for holding the side panels and delivering one from each side as each container is formed; adhesive application mechanisms; and a central panel forming station located near the end of the track.

In most embodiments, a mandrel is provided that includes at least two sets of grippers, one set on each of the opposite sides of the mandrel. Each set includes one or more motion-restricting grippers to receive and secure a side panel against the mandrel. These motion-restricting grippers are positioned at locations corresponding to non-shifting portions of said side panels, discussed more fully below in connection with the formation of the support pillars of the container. Each set also includes one or more toothed grippers that contain teeth angled toward the motion-restricting grippers. The toothed grippers are positioned at locations corresponding to the shifting portions of the side panels. The toothed grippers allow the shifting portions of the side panels to slide against the mandrel in one direction (usually toward the motion-restricting grippers) while preventing the side panels from backsliding in the other direction. The grippers also prevent the side panels from becoming misaligned or dislodged. It is to be appreciated that in other embodiments, one or more grippers may be provided on only one side of the mandrel for forming one or more support pillars on only one side of a finished container.

In most embodiments, a forming frame is provided that includes one or more rotating discs (score line breakers), one or more rollers (flat and/or angled), and/or one or more forming guides. The disc(s), roller(s).and/or guides may be provided on one side or on opposite sides of the interior passage. The rotating discs are positioned such that they make contact with and score the side panels (usually at pre-scored areas) as the mandrel moves through the passage. The rollers and guides are positioned to receive and deform the side panels after they are scored to form support pillars, and to affix the side panels to the central panel using applied adhesive.

One method of forming a container according to the present invention is described as follows: pre-scored side panels are inserted into the two opposite side hoppers, and pre-scored central panels are inserted into the overhead hopper. As the apparatus is activated, the mandrel progresses along the horizontal track, and picks up a side panel from each of the side hoppers. The motion-restricting gripper(s) of the mandrel secure the side panels to the mandrel. As the mandrel proceeds along the track, the side panels first contact the rotating disc(s) of the forming frame. An edge of each disc contacts a score line on each side panel, causing each side panel to be scored along said line. The pressure of this contact presses, or folds, the scored panel into the indentations of the mandrel; the pressure also causes portions of the side panel to slide relative to the mandrel. The toothed gripper(s) allow this sliding in one direction only. The contact and pressure from the disc(s) begins the initial formation of the support pillars of the reinforced side panels.

The shape of each support pillar is further defined by the angled and/or flat roller(s) and the forming guide(s) of the forming frame. Such definition causes both end portions of the side panels to shift toward the center. The alignment and position of the shifting side panels are secured by the toothed grippers, which allow the shifting portions of the panels to slide toward the non-shifting portion, while preventing those shifting portions from backsliding, or the entire side panel from being misaligned or dislodged.

As the mandrel moves forward, the overhead hopper discharges a central panel between the mandrel and panel forming station, and adhesive is applied to portions of this panel. As the support pillars of the reinforced side panels are being formed, the side panels contact the central panel. Once the support pillars are fully formed, the mandrel encounters a set of compression rollers which press the adhesive-coated central panel firmly against the side panels. At this point, the apparatus pauses briefly to allow the adhesive to bond. The mandrel then continues forward along the track, and forms the remainder of the Bliss box in the traditional fashion via the central panel forming station. The formed container is then ejected from the apparatus, and the mandrel is retracted to its starting position to repeat the assembly process with a new set of panels.

In most embodiments, sidewalls are introduced from stacks loaded into two hoppers, one on each side of the mandrel path. Usually, the sidewalls are loaded into the hoppers and supplied to the mandrel such that their longer dimension has as substantially vertical orientation. It is to be appreciated that the sidewalls of one or both stacks may be pre-scored, depending upon whether support pillars are desired on one or both sides of the container to be formed. It is also to be appreciated that one or more sets of score lines may be provided on a given sidewall, each set being used to form a separate support pillar. It is also to be appreciated that the support pillars formed in the sidewalls of the present invention typically have a V-shape, but that support pillars having other shapes may also be formed by the invention.

The following discussion is based on an embodiment in which both sidewalls are pre-scored to form two V-shaped support pillars. The foremost or front sidewall from each stack (one stack is on each side of the mandrel) is pressed against the side of the mandrel, and moved forward using grippers which engage the sidewall and bring it along the path with the mandrel. In this embodiment, it is to be appreciated that one portion of each sidewall, usually the center, will be pressed against the mandrel and will not move relative to the mandrel during the formation of the container. However, in this embodiment the leading and/or trailing (upper and lower) portions of the sidewalls on both sides of the mandrel will be moved relative to the mandrel in order to form the two support pillars along the score lines on each of the sidewalls. In this embodiment, two support pillars are to be formed on each sidewall, such that the central portion of each sidewall does not move, but that both the leading and trailing (upper and lower) portions will move. It is to be appreciated that in some embodiments only a single pillar is formed on each sidewall, and only one section of the sidewall will move relative to the mandrel in order to form that pillar. It is to be appreciated that in other embodiments multiple pillars may also be formed in a given sidewall, and that in such embodiments, each section where a pillar is to be formed will move relative to the mandrel, but that there will also be a section (however small) that will not move relative to the mandrel.

In order to facilitate the sliding motion and restrict it to only those portions of the sidewalls where pillars are to be formed, one or more motion restricting grippers or pics are provided on each side of the mandrel to hold a portion of each sidewall in place against the mandrel. The position(s) of these gripper(s) may be adjusted, and are set on the mandrel to correspond to a section of the sidewall that will not move relative to the mandrel. One or more toothed grippers are provided above and/or below the motion restricting grippers. In most embodiments, the teeth on these grippers are angled slightly towards the center of the mandrel, or generally towards the motion restricting grippers. This allows the portions of the sidewalls adjacent to the toothed grippers to slide against the mandrel and move toward the center or towards the motion restricting grippers, with the teeth preventing the sidewalls from backsliding away from the center or the motion restricting grippers. It is to be appreciated that toothed grippers are provided at or immediately adjacent to those regions where the pillars are to be formed so as to continue to engage a non-scored non-deformed section of the side panel as the pillar is being formed, as these are also the regions of the sidewalls that will slide against the mandrel as the pillars are formed.

In preferred embodiments, two pillars are to be formed on each side panel, one above the center and another blow the center of the mandrel. In these embodiments, adjustable toothed grippers are provided along the forward edges of the mandrel, with at least one gripper above center and another below center. The teeth of the upper gripper(s) are angled slightly downward, towards the center (motion restricting gripper(s)) of the mandrel. This allows the upper portion of each sidewall to slide against the mandrel and move down toward the center, with the teeth preventing the sidewall from backsliding (up) after such motion. Similarly, toothed grippers are provided below the center of the mandrel, with teeth angled slightly upwards, towards the center (motion restricting gripper(s)) of the mandrel. This allows the lower portion of each sidewall to slide against the mandrel and move up toward the center, with the teeth preventing the sidewalls from backsliding (down) after such motion.

The sliding motion of the moving portion(s) of the sidewalls is initiated by a rotating disc (score line breaker) that is encountered by the sidewall as the mandrel moves it horizontally through the machine. The discs are rigid horizontally oriented annular discs that are capable of rotation in a generally horizontal plane. The annular outside edges of the discs may be angled such that they form an annular point at the center to form V-shaped support pillars. In other embodiments, the discs may have other shapes to form support pillars with corresponding shapes. In the embodiments with pointed surfaces, these surfaces rotatably engage a score line on each sidewall as the mandrel moves forward, initiating a fold along the score line in the shape of a “V,” pushing the folded portion of the sidewall into a gap in the mandrel. These folds will eventually become V-shaped support pillars of the formed container. A disc is provided corresponding to a position of a score line on a sidewall, usually at least one disc is provided on each side of the mandrel. In preferred embodiments, four such discs are provided: two on each side, one for the upper (proximal) and another for the lower (distal) portion of each sidewall.

As the mandrel moves forward, the folding initiated by the contact between the rollers and the score lines on the sidewalls causes the sidewalls to slide relative to the mandrel. The teeth on the adjacent toothed grippers prevent these portions from backsliding. In the preferred embodiments, the leading (upper) portions of the sidewalls slide toward the center (down), and the trailing (lower) portions of the sidewalls also slide toward the center (up). The toothed grippers also prevent the sidewalls from unfolding, becoming misaligned, and/or dislodged.

As forward motion of the mandrel continues in forming embodiments with four pillars, the leading edges of the upper and/or lower ends of the sidewalls encounter angled rollers. These rollers push the sidewalls toward the center, further defining the support pillars according to the shape of the discs (V-shape or otherwise) along the folds started by the breaker discs. As forward motion continues, these flat rollers and a set of guides behind them put pressure on the side panels, compressing them towards the center, causing further pronouncement of the folds initiated by the pointed rollers. Meanwhile, a set of horizontal forming guides behind the pointed rollers further define the folded areas of the sidewalls as they move forward, preventing them from going back to flat. It is to be appreciated that the location(s) of these forming guides are on a horizontal plane that is slightly offset from that of the breaker discs. This is because the sidewalls have been moved by the breaker discs, as described above, as they are folded along the score lines. Once folded, the score lines are not in the same horizontal position as they were before the folding (having been slid along the mandrel) had taken place. The guides pick up the sidewalls in their now partially folded condition, whereas the breaker discs picked them up before any folding had taken place. The forming guides have a shape that conforms to the shape of the pillars to be formed (V-shape, U-shape, etc.). In some embodiments the breaker discs may be angled slightly from the horizontal in order to more smoothly transition the folding score lines to the horizontal guides, from their flat to folded positions.

As the mandrel has been moving forward, it has also picked up the base panel which has been sprayed or coated with adhesive at certain locations where it will eventually bond with the sidewalls. While the support pillars are being formed by the discs, rollers and forming guides, two edges of the base panel (which have adhesive on them) are being folded against portions of the sidewalls. When the V-pillars have been fully formed, the mandrel encounters a set of compression rollers which press the two edges of the base panel firmly against the sidewalls. At this point, the machine stops briefly to allow the adhesive between these surfaces to bond and set the support pillars in position.

After this pause, the mandrel continues forward along the path, forming the remainder of the container in a traditional fashion, which is then ejected. The mandrel then retracts, and the process repeats: a base panel is dropped in front of the retracted mandrel while adhesive is applied, another pair of sidewall panels are brought alongside the mandrel path, the rotating disc(s) and guide(s) form the pillar(s) as upper and/or lower portions of the sidewalls slide along the mandrel, the teeth on the mandrel grippers prevent backsliding, the mandrel pauses briefly to set the position of the pillar(s), and the mandrel moves forward to form the remainder of the box, etc.

It is therefore an object of the present invention to provide machines, methods and apparatus for forming containers having side panels with one or more support pillars thereon.

It is another object of the present invention to provide machines, methods and apparatus for rapidly and automatically forming containers having one or more side panel support pillars thereon.

It is another object of the present invention to provide adjustable machines, methods and apparatus for forming containers of different sizes having one or more side panels with one or more support pillars thereon.

It is another object of the present invention to provide adjustable machines, methods and apparatus for forming containers having one or more side panels with one or more support pillars thereon in different locations depending on the container to be formed.

It is another object of the present invention to provide machines, methods and apparatus that minimize the potential for container forming problems such as misaligned or dislodged boxes, machine jams, or the like.

Additional objects of the invention will be apparent from the detailed description and claims herein.

### BRIEF DESCRIPTION OF THE DRAWINGS

FIG. 1 is a series of views showing the formation of an exemplary box according to an embodiment of the methods and apparatus of the present invention.

FIG. 2 is a side perspective view of an embodiment of a mandrel of the present invention.

FIG. 3 is a front sectional view of an embodiment of the present invention along the mandrel path showing the formation of a container.

FIG. 4 is a side sectional view of an embodiment of the present invention along the mandrel path showing the formation of a container.

FIG. 5 is a top sectional view of an embodiment of the present invention along the mandrel path.

FIG. 6 shows detail of an embodiment of a rotatable disc used in embodiments of the present invention.

FIG. 7 is a perspective front and left side view of an embodiment of a partial machine of the present invention, without the mandrel or other components.

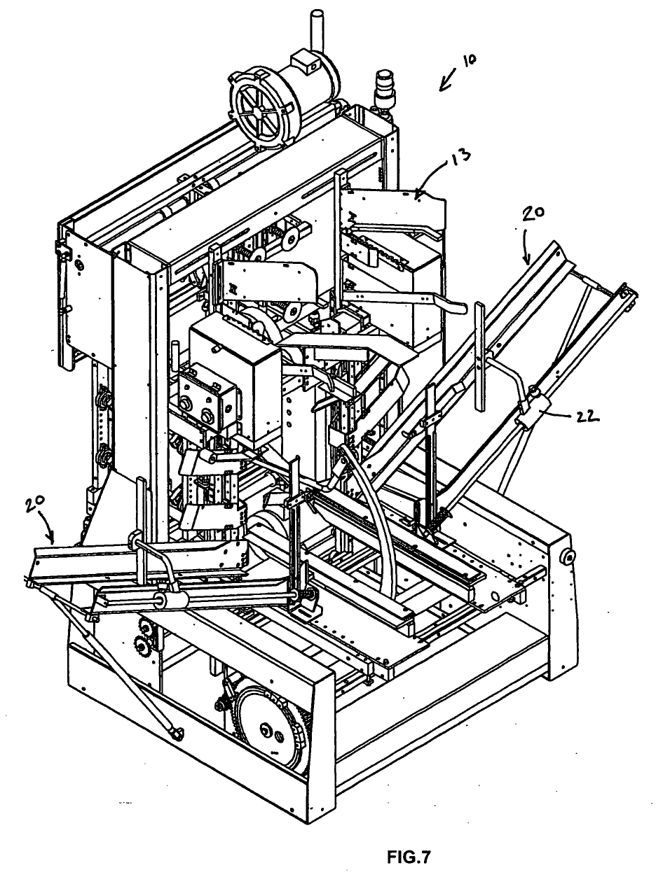

FIG. 8 is a perspective front and right side view of the embodiment of FIG. 7.

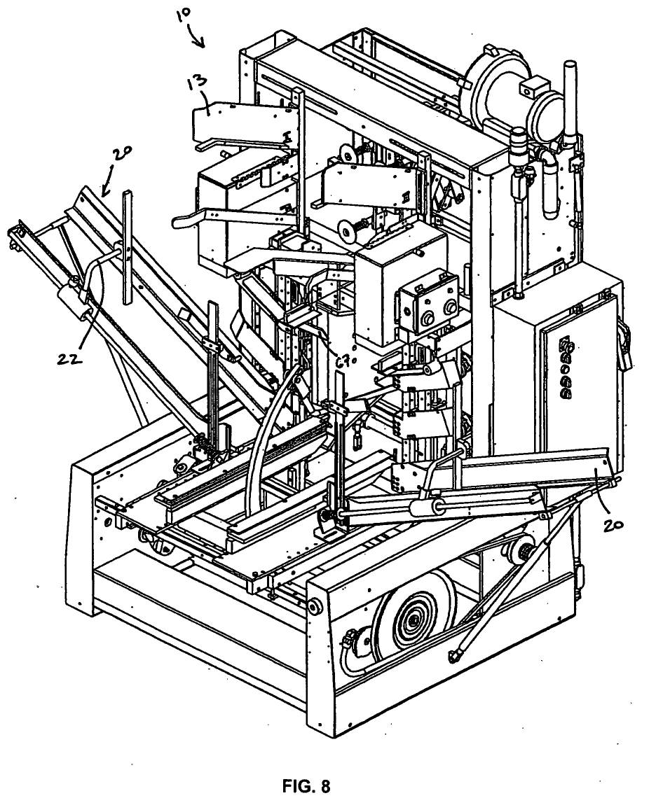

FIG. 9 is a perspective rear and right side view of the embodiment of FIG. 7.

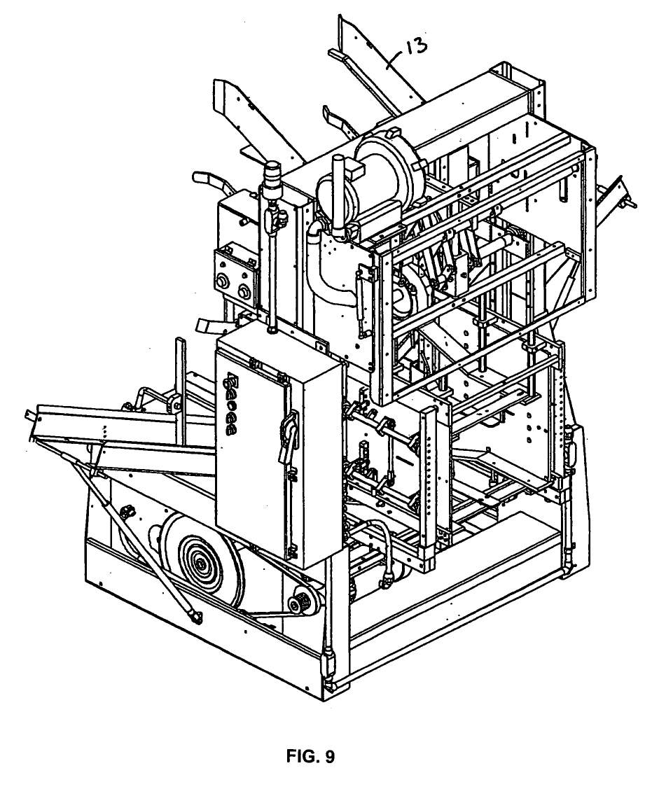

FIG. 10 is a perspective rear and left side view of the embodiment of FIG. 7.

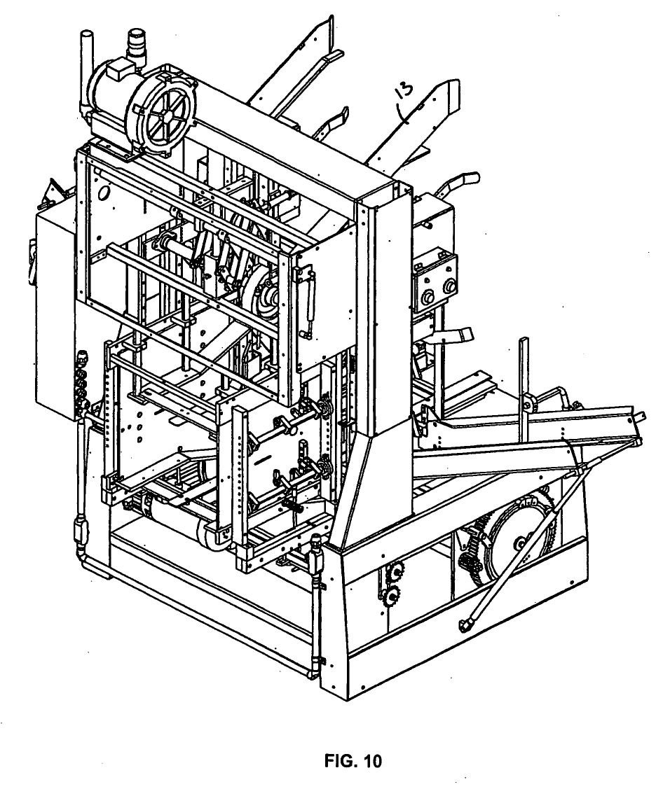

FIG. 11 are detailed side and top views of an embodiment of a toothed pic used in embodiments of the present invention.

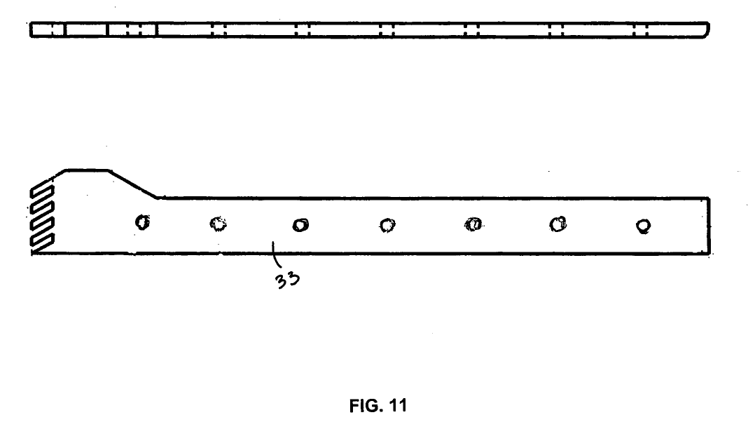

FIG. 12 is a perspective front and left side view of another embodiment of a partial machine of the present invention, with a partial cutaway view; and without a mandrel, overhead feed, side feeds, and other components.

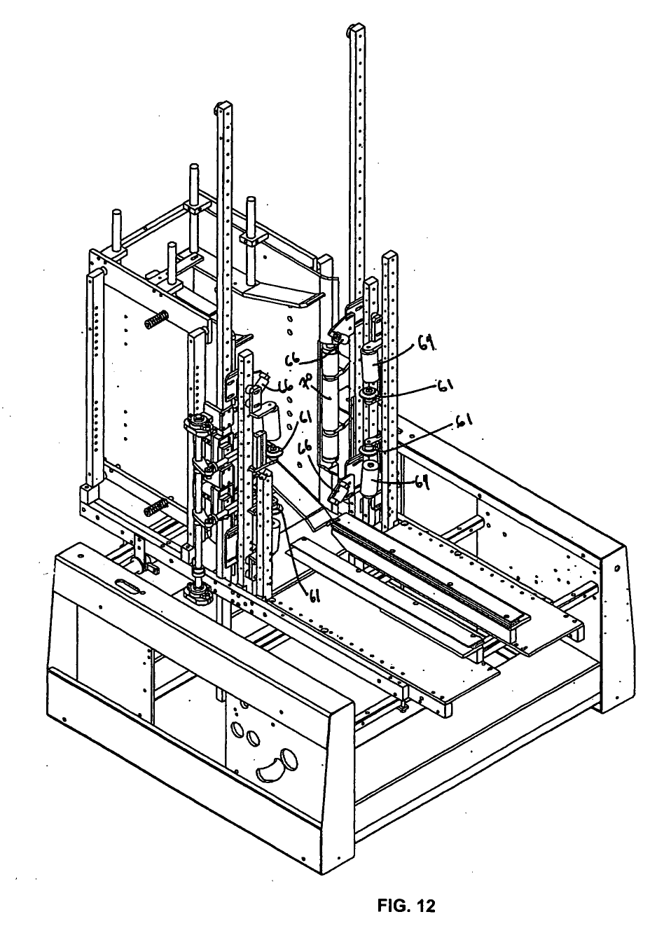

FIG. 13 is a perspective front and right side view of the embodiment of FIG. 12.

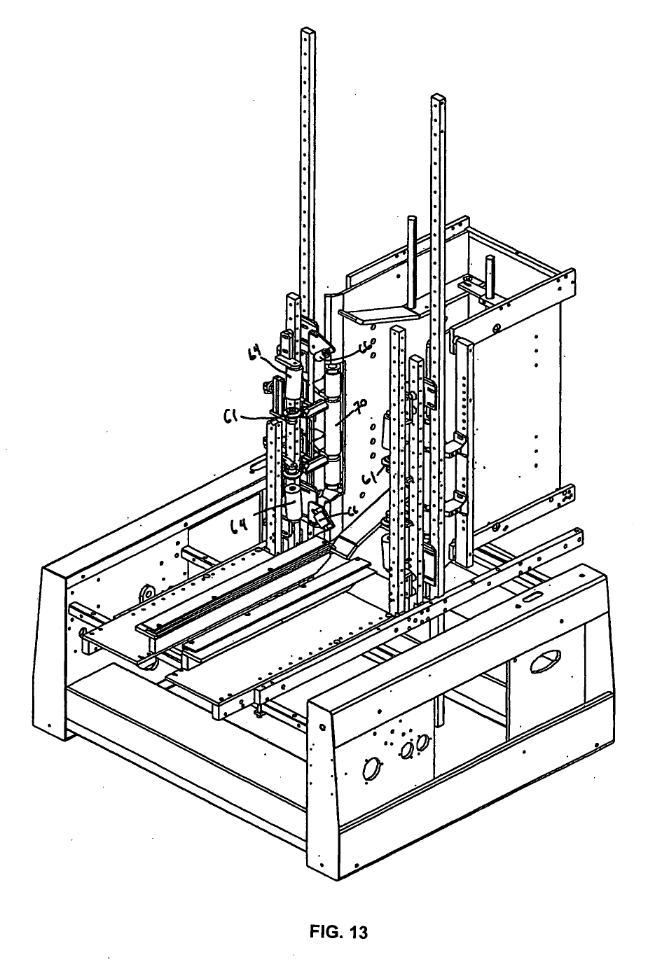

FIG. 14 is a perspective rear and right side view of the embodiment of FIG. 12.

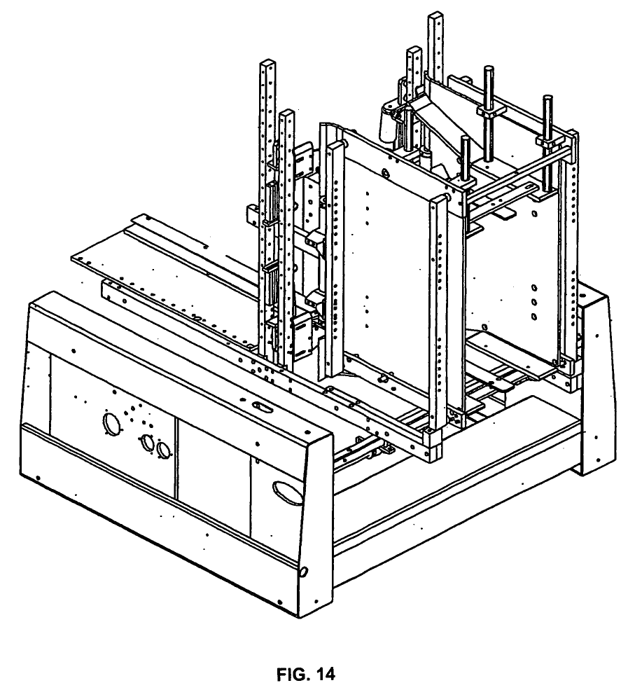

FIG. 15 is a perspective rear and left side view of the embodiment of FIG. 12.

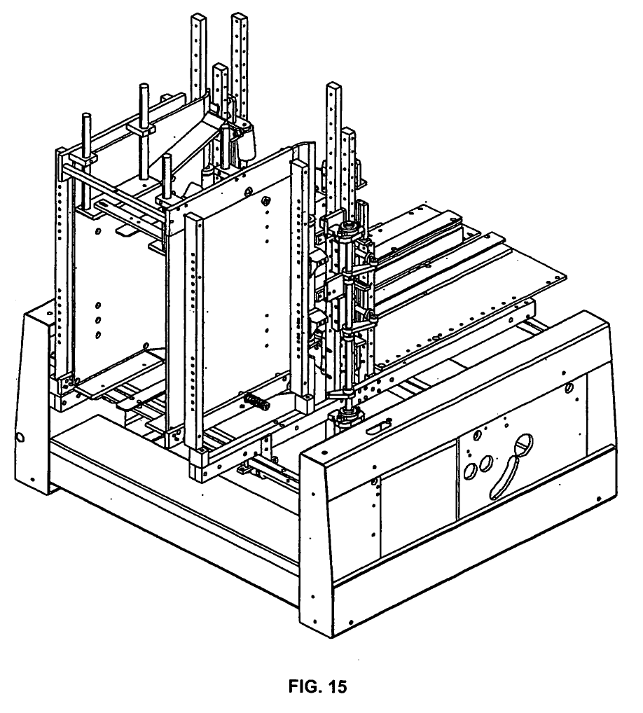

FIG. 16 is a perspective front and left side view of another embodiment of a partial machine of the present invention, with a partial cutaway view, without a mandrel and without one side feed.

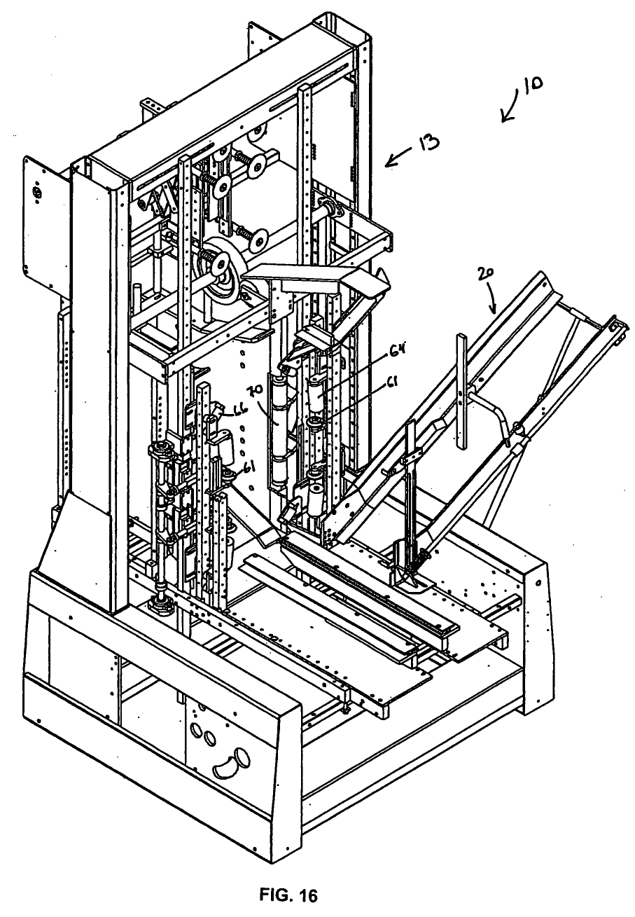

FIG. 17 is a perspective front and left side view of the embodiment of FIG. 16, with both side feeds.

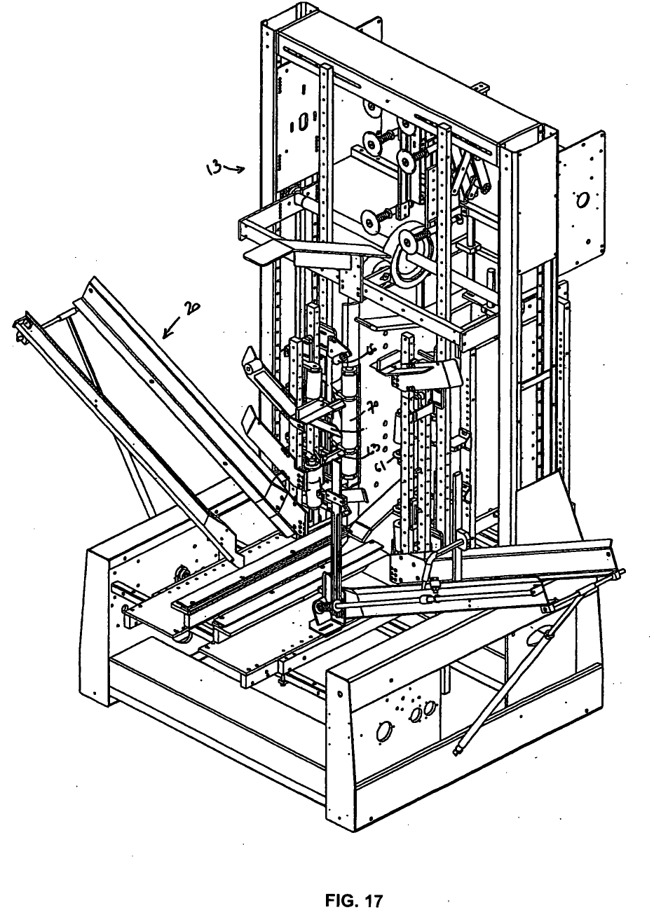

### DETAILED DESCRIPTION

Referring to the exemplary embodiments of the drawings wherein like reference characters designate like or corresponding parts throughout the several views, it is seen that an embodiment of the present invention includes a container forming machine 10 having a mandrel 11 that is capable of movement along a generally path between retracted and extended positions. A feed 13 provides a base panel 41 for a Bliss style container, the base panel 41 including integral end panels 43A and 43B separated from base panel 41 by score lines 45. Base panel 41 also includes side panel flaps 47A and 47B. A pair of sidewall hoppers 20 are provided along both sides of the mandrel path. One or more rollers, plows and guides are provided along the path of the mandrel 11 for forming a Bliss style container, as described hereinbelow.

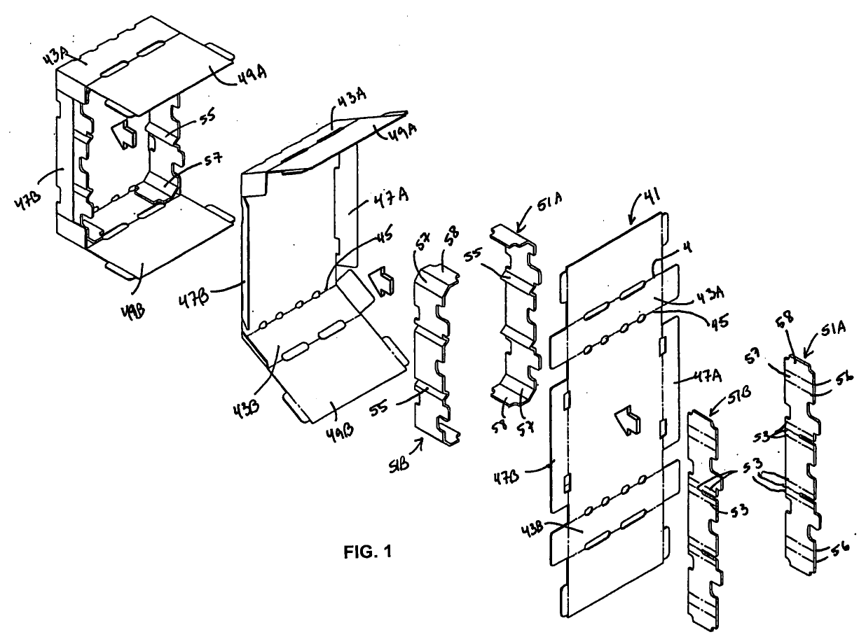

The exemplary embodiment illustrated in FIGS. 1-5 forms two support pillars 55 on each side panel. It is to be appreciated that in other embodiments more or fewer pillars may be formed, and that the apparatus and methods of the invention described herein may be adapted to include more or fewer components to accomplish the formation of the desired number of support pillars 55 on each sidewall, including providing a different number of pillars on each side of a given container.

It is to be understood that while the following is a description of an exemplary embodiment used to form a sidewall 51A on one side of the mandrel, in this embodiment a mirror image set of the same components may also be provided on the other side of the mandrel path. In this embodiment, each sidewall 51A and 51B includes one or more sets of score lines 53 to form diagonal or V-shaped support pillars 55 in the sidewalls. In some embodiments, sidewalls 51A and/or 51B may also be provided with additional score lines 53 to form pillars of different shapes, and/or score lines 56 to form diagonal corner reinforcement panels 57 at one or both ends of the sidewall.

In the illustrated embodiment, two sets of score lines 53 are provided on each sidewall to form two V-shaped pillars 55. However, in other embodiments, a single set of score lines 53 may be provided, such that only a single group of devices is provided on the apparatus or in a machine or method to form such a single pillar in the sidewall. In other embodiments, multiple pillars may be formed on each sidewall, requiring a corresponding number of devices to form such pillars. In some embodiments a different number of pillars (including none) may be provided on first sidewall 51A than on second sidewall 51B.

The sidewalls 51A and 51B are provided in hoppers 20 in generally vertically oriented stacks on either side of the mandrel 11, at locations along the mandrel path that are encountered by the mandrel before the base panel 41 is encountered when the mandrel is moving forward. The sidewalls 51A and 51B are preferably loaded such that orientation of the lowermost sidewall of each stack is generally perpendicular to base panel 41, so that the first or lowermost sidewall 51A or 51B of each stack rests against or is pressed against a side of mandrel 11.

The illustrations of FIG. 1 are a series of “snapshots” showing several stages of formation of a container by the present invention, the stages progressing from right to left, as indicated by the large arrows. The first stage shows the base panel 41 having been dropped in front of the mandrel, with two side panels 51A and 51B (at the bottoms of their respective stacks of panels) pressing against the sides of the mandrel 11. This pressure may be induced by any appropriate method including without limitation gravity, the weight of the stack of side panels, a weight placed on the stack of side panels, a spring or other compression device 22, etc. The next illustration in FIG. 1 shows the formation of exemplary support pillars 55 and exemplary corner reinforcements 57, 58 on the two illustrated side panels 51A and 51B. The next illustration of FIG. 1 shows the folding of the exemplary base panel 41 prior to insertion of the side panels 51A and 51B therein. The final illustration of FIG. 1 shows both side panels 51A and 51B inserted into and adhered to base panel 41, such that the bottom and four sides of the exemplary container have been formed. The top panels 49A and 49B are left open so that they may be folded and closed at another time, after products have been loaded into the container.

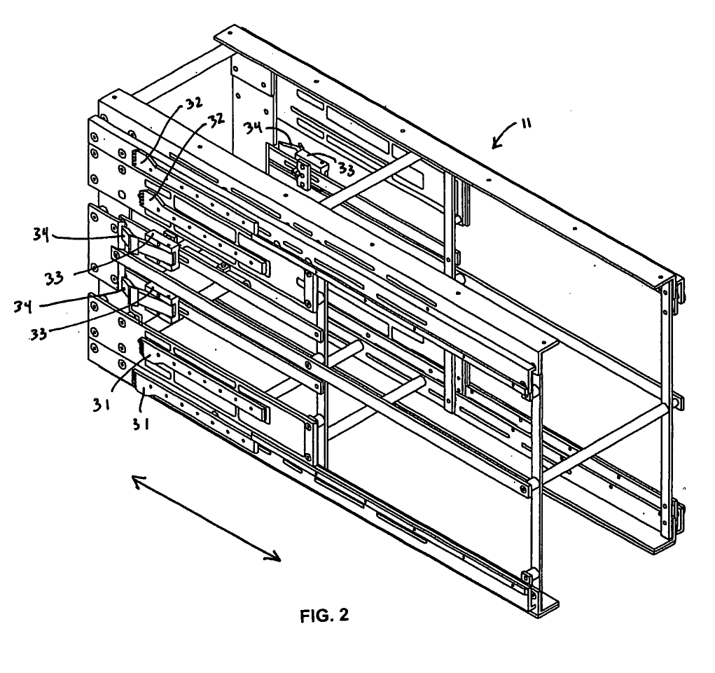

FIG. 2 of the exemplary embodiment illustrates a configuration for a mandrel that is used when forming sidewalls having two support pillars 55 thereon. The first or foremost sidewall 51 from each stack is removed using grippers or pics 31, 32 and/or 33. The positions of all grippers may be adjusted to conform to the various contours of the edges of the sidewalls 51. These grippers engage the sidewall 51 and bring it alongside the mandrel 11. One or more central grippers 32 may include a motion restricting mechanism 34 such as a biased flange member which holds the removed sidewall 51 against the side of mandrel 11. The portion of the sidewall 51 that is engaged by devices 34 does not move or slide relative to the mandrel 11 during formation of the container. However in the illustrated embodiment, the upper and lower portions of the sidewall 51 will be moved relative to the mandrel in order to form the support pillars 55 along the score lines 53 on the sidewall. In order to facilitate this motion and restrict it to only the upper and lower portions of the sidewalls, the central grippers 32 hold the center sections of the sidewall firmly in place against the mandrel 11 using the motion restricting mechanism 34.

In the illustrated embodiment of FIG. 2, different toothed grippers 31 and 33 are provided above and below the central gripper(s) 32. Teeth are provided on grippers 31 and 33 that are angled towards the central grippers 32 and motion restricting devices 34. The teeth on upper gripper 31 are angled slightly downward towards the center of the mandrel. This allows the upper portions of the sidewall 51 to slide against the mandrel and move down toward the center, with the gripper 31 teeth preventing these portions of the sidewall from backsliding (up) after such motion. Similarly, teeth on the lower grippers 33 are angled slightly upwards towards the center of the mandrel. This allows the lower portions of the sidewall 51 to slide against the mandrel and move up toward the center, with the gripper 33 teeth preventing these portions of the sidewall from backsliding down after such motion.

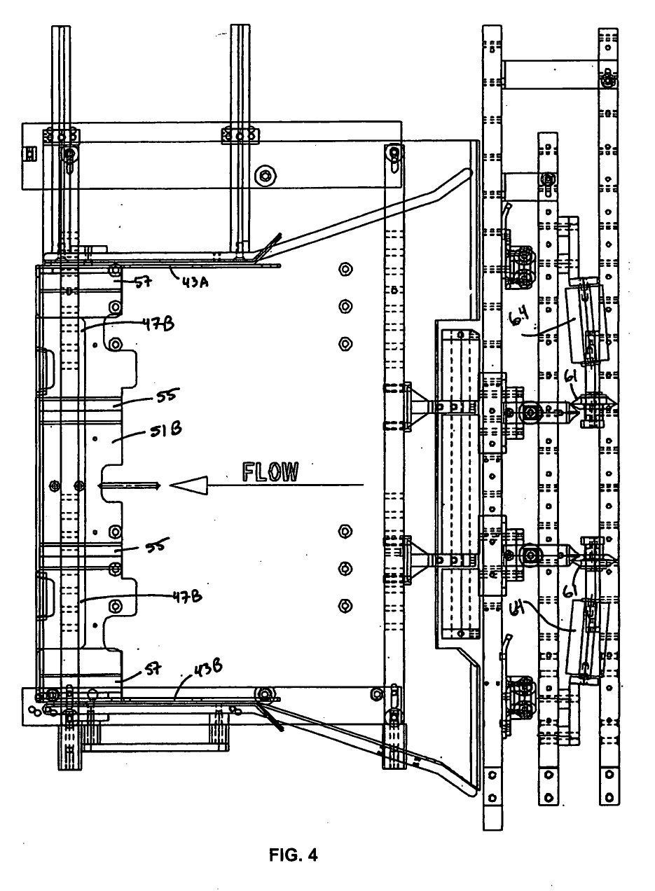

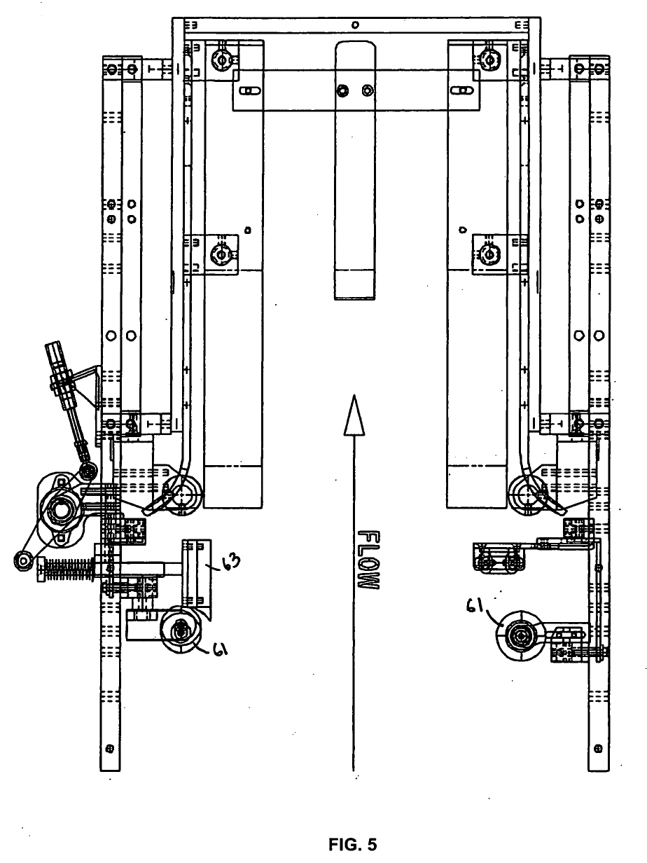

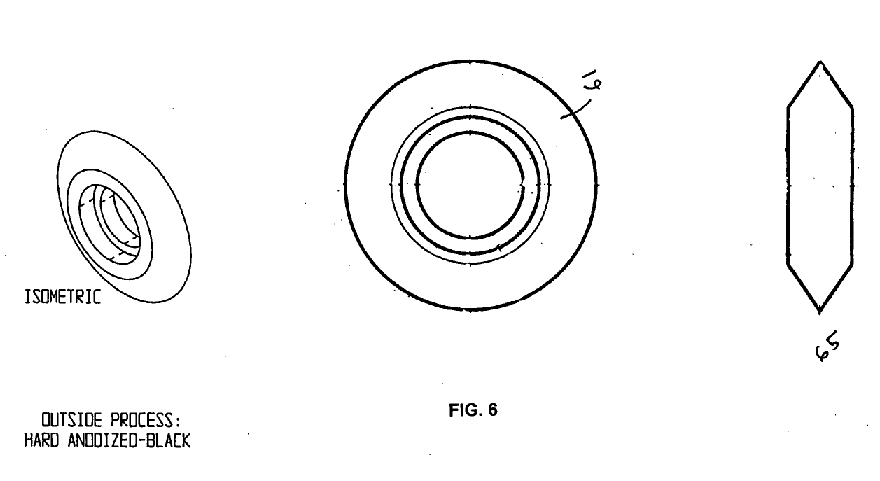

Referring to FIGS. 4 and 5, in the exemplary embodiment, the sliding motion of the upper and lower portions of the sidewall 51 relative to mandrel 11 is initiated by rotatable discs 61 that are encountered by the sidewall 51 as the mandrel moves along the path. In the illustrated exemplary embodiment, four discs 61 are provided, two on each side of the mandrel, one for the leading and another for the trailing portion of each sidewall 51. It is to be appreciated that in other embodiments, more or fewer discs 61 (or none at all) may be provided on either side of the mandrel path. The illustrated discs 61 are of annular form and are capable of rotation in a plane that is generally parallel to the path of the mandrel. In some embodiments discs 61 may be angled, as described below, to facilitate transition to forming guides 63. Detail of some embodiments the discs 61 is shown in FIG. 6. In these illustrated embodiments, the annular outside edges of the discs are angled such that they form an annular point 65 at the center. However, in other embodiments the outside edges of the discs 61 may have other shapes, or multiple points. The pointed edges 65 rotatably engage a score line 53 on each sidewall as the mandrel moves forward, initiating a fold along the score lines 53 which begins the formation of a support pillar in the shape of a “V”, while also pushing the folded portion of the sidewall into a gap in the mandrel. These folds will eventually become a V-shaped support pillar of the completed container.

As the mandrel moves forward, the folding initiated by the contact between the discs 61 and the score lines 53 on the sidewall 51 causes the sidewall to slide relative to the mandrel. The upper portion of the sidewall slides toward the center (down), and the lower portion of the sidewalls also slides toward the center (up). The teeth on the grippers 31 and 33 prevent these portions from backsliding, becoming misaligned, or dislodging. Side rollers 64 assist in this movement.

In some embodiments such as that illustrated in the drawings where corners are to be formed, as forward motion of the mandrel continues, panels 57 of the upper and/or lower ends of the sidewalls 51 encounter rollers 66 which are angled relative to the horizontal. Rollers 66 push the bend the panels 57 along score lines 56 forming the corner reinforcement(s); rollers 66 also push the sidewalls toward the center, further defining the V-shaped support pillars 55 along the folds 53 started by the discs 61. As forward motion continues, a set of guides 67 behind the rollers 66 put pressure on the outside edges 58 of the side panel 51, further folding the side panel 51 so that it has the appearance shown in the second phase of FIG. 1.

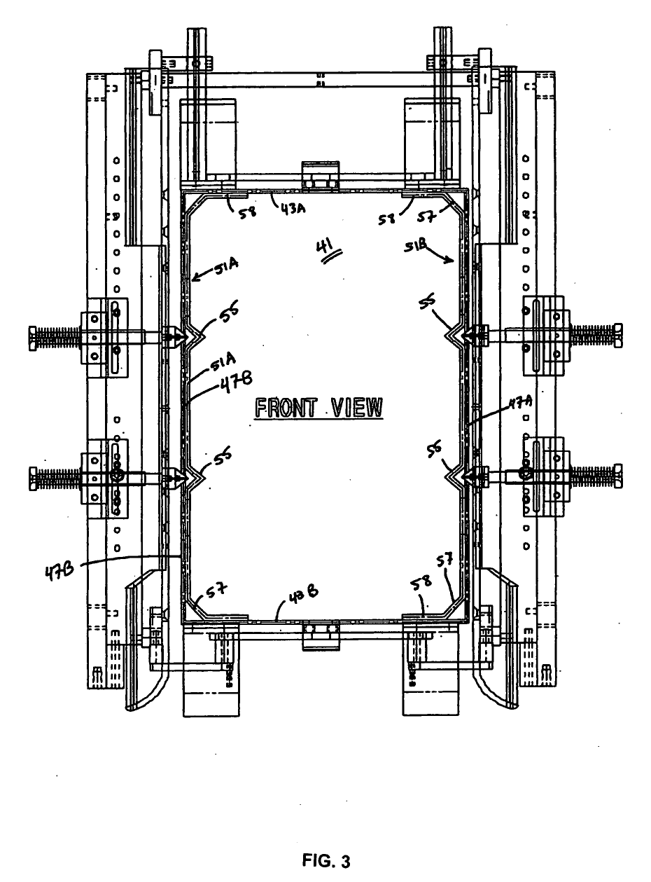

As the mandrel moves forward, the side panel 51 moves from discs 61 to a set of forming guides 63 further along the mandrel path from the discs 61, which further define the folded pillars 55 of the sidewalls as they move forward, preventing them from going back to flat. In some embodiments guides 63 are capable of lateral movement (towards and away from mandrel 11) in order to engage, and then disengage pillars 55. It is to be appreciated that guides 63 should have the same shape as the pillars 51 to be formed. In the illustrated embodiments (FIGS. 3-4), this shape is in the form of a “V.” Guides 63 are preferably sized to be approximately the same length as the sidewall, so as to fill each entire pillar 55. In some embodiments, guide(s) 63 may be offset from disc(s) 61; in other embodiments, disc(s) 61 may be angled slightly to transition the partially folded pillar(s) 55 of the side panel 51 to guide(s) 63 as pillar(s) 55 are being formed. It is to be appreciated that the folding of panels 51 by disc(s) 61 along score lines 53 causes each panel 51 to slide against mandrel 11, moving the positions of each pillar 55 as it is being formed.

As the mandrel has been moving forward, it has also picked up the base panel 41 which has been sprayed or coated with adhesive at certain locations where it will eventually bond with the sidewalls 51A and 51B. After the V-shaped pillars 55 are formed as described above, two edges 47A and 47B of the base panel (which have adhesive on them) are pressed against portions of the sidewalls using side compression rollers 70 and press plates 72 which press the two edges 47A and 47B of the base panel 41 firmly against the sidewalls 51A and 51B. At this point, the machine stops briefly to allow the adhesive between these surfaces to bond and set the V-shaped pillars in position against panels 47A and 47B. At this point, plates 72 move inward to press side panels 51A and 51B against edges 47A and 47B of the base panel 41. An example of this is shown in the last phase illustrated in of FIG. 1.

It is to be appreciated that some embodiments of the present invention may require the formation of additional or fewer V-shaped pillars 55 in each side panel 51A, 51B, that the diagonal corner reinforcement panels 57 or other reinforcement features may be implemented or removed, or that any of the features may need to be moved to other locations on the side panels 51A, 51B. Such requirements may be satisfied by adding, removing or relocating the motion-restricting grippers 34, toothed grippers 31/33, rotating discs 61, side rollers 64, 66, 70 and/or forming guides 63. It is also to be appreciated that such customization may be easily made by utilizing movable and/or removable components, and installing tracks and multiple connection points for said components. It is to be appreciated that any number of reinforcement features, including additional V-shaped pillars or multi-layered paperboard, may be formed by utilizing different combinations of the above forming components.

After the pause, plates 72 retract and mandrel 11 continues forward along the path, forming the remainder of a container in a traditional fashion. The mandrel then retracts, and the process repeats: a base panel 41 is dropped in front of the retracted mandrel 11 while adhesive is applied, another pair of sidewall panels 51 are brought alongside the mandrel path, the rotating discs 61 and guides 63 form the pillars as upper and lower portions of the sidewalls slide along the mandrel, the teeth on the mandrel grippers 31 and/or 33 prevent backsliding, the corners are formed using rollers 66, the mandrel pauses briefly to set the position of the V-shaped pillars 55, then the mandrel moves forward to form the remainder of the box, etc.

It is to be appreciated that any number of discs 61, guides 63, and related devices (toothed mandrel grippers 31 & 33, rollers 66, compression rollers 67, plates 72, etc.) may be provided for each sidewall panel 51A or 51B, depending upon the number of pillars to be formed on the particular sidewall panel.

It is to be understood that variations and modifications of the present invention may be made without departing from the scope thereof. It is also to be understood that the present invention is not to be limited by the specific embodiments disclosed herein, but only in accordance with the appended claims when read in light of the foregoing specification.

What is claimed is:

1. An apparatus for forming containers from three parts comprising:
a. a mandrel movable along a path from retracted to extended positions;
b. at least one first gripper on a side of said mandrel for holding a side panel blank against said mandrel;
c. at least one toothed gripper on a side of said mandrel for engaging a side panel blank against said mandrel and allowing said side panel to slide in one direction along said mandrel;
d. at least one rotatable disc located along the path of said mandrel for bending a portion of said side panel; and
e. at least one guide located adjacent to said disc along the path of said mandrel for forming the bent portion of said side panel into a support structure of a container being formed.

2. The apparatus of claim 1 wherein the position of said guide is offset from the position of said disc.

3. The apparatus of claim 1 wherein said rotatable disc is mounted at an angle relative to the path of said mandrel.

4. The apparatus of claim 1 wherein said rotatable disc has an annular pointed edge.

5. The apparatus of claim 1 wherein the teeth of said toothed gripper are angled.

6. The apparatus of claim 1 wherein said first gripper includes a clamp for holding said sidewall against said mandrel.

7. The apparatus of claim 1 wherein the position of said at least one first gripper on said mandrel is adjustable

8. The apparatus of claim 1 wherein the position of said at least one toothed gripper on said mandrel is adjustable

9. The apparatus of claim 1 wherein at least one roller is provided along the path of said mandrel for bending an end of said side panel, said roller being mounted at an angle relative to the path of said mandrel.

10. The apparatus of claim 1 wherein at least one pressure imparting device is provided along the path of said mandrel for compressing a portion of said side panel against a portion of a base panel.

11. An apparatus for forming containers comprising:
a. a mandrel movable along a path from retracted to extended positions;
b. at least one adjustable first gripper with clamp located on a side of said mandrel for holding a side panel blank against said mandrel;
c. at least one adjustable second gripper having angled teeth thereon located on a side of said mandrel for engaging a side panel blank against said mandrel and allowing said side panel to slide in one direction along said mandrel;
d. at least one rotatable disc located along the path of said mandrel for bending a portion of said side panel; and
e. at least one guide located along the path of said mandrel adjacent to and offset from said disc for forming the bent portion of said side panel into a support structure of a container being formed.

12. A machine for forming containers having at least one side support structure comprising:
a. a mandrel movable along a path from retracted to extended positions;
b. a first hopper provided along one side of said path for holding a side panel of a container to be formed;
c. a second hopper provided along the opposite side of said path for holding an opposite side panel of a container to be formed;
d. an feed provided along said path for feeding body panels into said path;
e. at least one adjustable first gripper having a clamp thereon located on a side of said mandrel for holding a side panel blank against said mandrel;
f. at least one adjustable second gripper having angled teeth thereon located on a side of said mandrel for engaging a side panel blank against said mandrel and allowing said side panel to slide in one direction along said mandrel;
g. at least one rotatable disc located along the path of said mandrel for bending a portion of one of said side panels;
h. at least one guide located along the path of said mandrel adjacent to and offset from said disc for forming the bent portion of said side panel into a support structure of a container being formed; and
i. a forming station located near the end of said path for completion of the formation of said container.

13. A method for forming a reinforcement pillar on a side wall of a container comprising the steps of:
a. placing at least one first side panel having at least one pre-scored area thereon into a hopper provided along one side of a path of a movable mandrel;
b. advancing said mandrel along said path such that the mandrel picks up said side panel from said hopper using at least one gripper located on a side of said mandrel;
c. advancing said mandrel further along said path such that said side panel contacts a rotatable disc which begins folding said side panel along said score lines forming at least one deformed area thereon; and
d. advancing said mandrel further along said path such that each such deformed area encounters a guide that further forms the shape of said area into a support pillar.

14. A method for forming a container having a reinforcement pillar on a side wall thereof comprising the steps of:
a. placing at least one first side panel having at least one pre-scored area thereon into a hopper provided along one side of a path of a movable mandrel;
b. placing at least one second side panel into a hopper provided along an opposite side of said path;
c. placing at least one container body panel into a feed mechanism located along the path of said mandrel downstream from said side panel hoppers;
d. applying adhesive to said body panel;
e. advancing said mandrel along said path such that the mandrel picks up each of said side panels from said hoppers using at least one gripper located on each side of said mandrel;
f. advancing said mandrel further along said path such that at least one of said side panels encounters a rotatable disc which begins folding said side panel along said score lines forming at least one deformed area thereon;
g. advancing said mandrel further along said path such that each such deformed area encounters a guide that further forms the shape of said area into a support pillar; and
h. compressing said side panel with support pillar against said body panel.

15. The method of claim 14 comprising the further step of pausing briefly to allow adhesive between said side panel and said body panel to begin setting

16. The method of claim 15 comprising the further step of advancing said mandrel further along said path to form the remainder of said container using at least one forming plow and plate.

17. The method of claim 16 comprising the further step of displacing said container.

18. The method of claim 13 wherein a portion of said side panel slides against said mandrel during said folding process.

18. The method of claim 13 wherein at least one diagonally oriented roller is provided along the path of said mandrel adjacent to said at least one disc, and comprising the further step of bending an end of a side panel using said roller.
